(19) United States
(12) Patent Application Publication
(10) Pub. No.: US 2026/0121509 A1
(43) Pub. Date: Apr. 30, 2026

(54) MEDIUM VOLTAGE AC TO MULTIPORT LVDC CONVERTER WITH INTER-MODULE TRANSFORMER (IMT)

(71) Applicants: Delta Electronics India Pvt Ltd., Haryana (IN); Department Of Electrical Engineering, Indian Institute of Science (IISc), Karnataka (IN)

(72) Inventors: Saichand KASICHEYANULA, Karnataka (IN); Harisyam P V, Karnataka (IN); Surjakanta MAZUMDER, Karnataka (IN); Kaushik BASU, Karnataka (IN); Shashidhar MATHAPATI, Karnataka (IN)

(21) Appl. No.: 19/340,897

(22) Filed: Sep. 26, 2025

(30) Foreign Application Priority Data
Oct. 25, 2024 (IN) 202411081519

(51) Int. Cl. H02M 1/00; H02M 1/42; H02M 7/217; H02M 7/219

(52) U.S. Cl. CPC H02M 1/007; H02M 1/0003; H02M 1/0043; H02M 1/009; H02M 1/4233; H02M 7/2173; H02M 7/219

(57) ABSTRACT

The present disclosure relates to a medium voltage AC to multiport low voltage DC converter. The converter comprises a plurality of cascaded H-bridge (CHB) converters configured to receive a Medium Voltage AC input, wherein each of the cascaded H-bridge converter comprises a plurality of primary AC-DC H-bridge modules and configured to transfer power from the Medium Voltage AC input, a plurality of main transformers each correspondingly coupled to one of the primary AC-DC H-bridge modules to form an HFAC node, wherein each of the main transformers is configured to convert power from an intermediate DC bus to a DC-HFAC stage of a primary module into a HFAC output and a plurality of load ports each correspondingly coupled to one of the HFAC nodes via a secondary AC-DC H-bridge module for individually providing an independent low voltage direct current (LVDC) output at each of the load ports.

### CROSS-REFERENCE TO RELATED APPLICATION

The present application claims priority to India Patent Application No. 202411081519, filed with Indian Patent Office on Oct. 25, 2024 and entitled “A MEDIUM VOLTAGE AC TO MULTIPORT LVDC CONVERTER WITH INTER-MODULE TRANSFORMER (IMT)”. The disclosure of the aforementioned application is hereby incorporated by reference in its entirety.

### TECHNICAL FIELD

The present disclosure relates to power converter and more particularly to a medium voltage AC (MVAC) to multiport low voltage DC (LVDC) converter with inter-module transformer (IMT) at low voltage side.

### BACKGROUND

In recent times, there has been increased integration of renewable and energy storage devices to Alternating current (AC) grid. To that effect, there is a sharp increase in connected direct current (DC) systems such as solar photovoltaic (PV), electrical vehicles (EVs) and energy storage devices, etc. In existing art, there are several systems with power electronic topologies for providing power supply to multiple isolated DC systems from an AC power grid.

In an electric vehicle (EV) charging station with multiple EV chargers, the power requirements of each EV charger have well exceeded beyond 100 kW. Today's high-power fast charging stations use low voltage high power chargers. However, as the EV charging stations' power requirements increase, drawing power directly from the medium-voltage grid is recommended to improve the system efficiency. In recent times, since the power capacity of electric vehicle chargers has exceeded 100 kW, charging multiple vehicles simultaneously in the charging station puts a huge load on the LVAC grid systems.

In order to reduce the carbon footprint of transportation, it is also preferred to use green energy from renewable when available instead of using a fossil fuel-based grid. Local energy storage is also required for fast charging stations to improve grid stability.

Therefore, to solve the above-mentioned problems, there is a need in the art for an improved and efficient power converter topology for charging stations.

### OBJECTIVE OF THE DISCLOSURE

The objective of the present disclosure is to provide a medium voltage AC (MVAC) to multiport low voltage DC (LVDC) converter with inter-module transformer (IMT) at low voltage side for electric vehicle charging stations which handles the excess or deficit of load power between the multiple DC ports and eliminates bulky line frequency transformer (LFT) utilized for the isolation of medium voltage AC (MVAC) from the low voltage DC (LVDC) ports.

### SUMMARY

An aspect of the present disclosure is to address at least the above-mentioned problems and/or disadvantages and to provide at least the advantages described below.

Accordingly, in one aspect of the present disclosure relates to a power converter system (100). The power converter system (100) comprises a plurality of cascaded H-bridge (CHB) converters (120) configured to receive a medium voltage AC (MVAC) input (110), wherein each of the cascaded H-bridge converter comprises a plurality of primary modules configured to transfer power from the MVAC input. Each primary module consists of AC-DC H-bridge module, intermediate DC bus and DC-HFAC stage. The AC-DC H-bridge module of each primary module receives AC input and generates DC to the intermediate DC bus. The following DC-HFAC stage of the primary module uses this DC from intermediate DC bus and generates the corresponding HFAC node. The power converter system (100) comprises a plurality of main transformers (130) each correspondingly coupled to one of a plurality of DC-HFAC stage with a primary AC-DC H-bridge module, wherein each of the main transformers is configured to convert power from an intermediate DC bus (125) into a high-frequency alternating current (HFAC) node and a plurality of load ports (140) each correspondingly coupled to one of the HFAC nodes via a secondary AC-DC H-bridge module (145) for individually providing an independent low voltage direct current (LVDC) output at each of the load ports.

Another aspect of the present disclosure relates to a medium voltage alternating current (MVAC) to multiport low voltage dc (LVDC) converter. The converter comprises a plurality of cascaded H-bridge (CHB) converters (120) configured to receive a Medium Voltage AC (MVAC) input (110), wherein each of the cascaded H-bridge converter comprises a plurality of primary AC-DC H-bridge modules operative with controlled low frequency modulation signals with phase-shift modulation between series connected modules and configured to transfer power from the Medium Voltage AC (MVAC) input. The converter further comprises a plurality of main transformers (130) each correspondingly coupled to one of the primary AC-DC H-bridge modules (145) to form an HFAC node, wherein each of the main transformers is configured to convert power from an intermediate DC bus (125) to a DC-HFAC stage of a primary module into a high-frequency alternating current (HFAC) output and a plurality of load ports (140) each correspondingly coupled to one of the HFAC nodes via a secondary AC-DC H-bridge module (145) for individually providing an independent low voltage direct current (LVDC) output at each of the load ports.

Further aspect of the present disclosure relates to a method (900) for converting a medium voltage alternating current (MVAC) input into a plurality of low voltage direct current (LVDC) outputs. The method comprising receiving (910) MVAC input at plurality of cascaded H-bridge converter, the cascaded H-bridge converter comprising a plurality of primary AC-DC H-bridge modules operable with phase-shift modulation between the modules and configured to transfer power from the MVAC input, converting (920) power from an intermediate DC bus into a high-frequency alternating current (HFAC) output by electrically energizing plurality of main transformers each coupled to a DC-HFAC stage of a primary module correspondingly and providing (930) the converted HFAC output to a plurality of load ports, each load port configured to convert the received HFAC output via a secondary AC-DC H-bridge module into an independent low voltage direct current (LVDC) output at each of the load ports.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference features and modules.

FIG. 1 illustrates block diagram representation of MVAC to multiport LVDC converter (Topology 1) using an additional bridge (aux) and m number of two-winding transformers according to an exemplary implementation of the present disclosure.

FIG. 2 illustrates block diagram representation of MVAC to multiport LVDC converter (Topology 2) using m-winding Inter-Module Transformer (IMT) according to an exemplary implementation of the present disclosure.

FIG. 3 illustrates block diagram representation of MVAC to multiport LVDC converter (Topology 3) using additional bridge (aux) and an (m+1)-winding inter module transformers according to an exemplary implementation of the present disclosure.

FIG. 4 illustrates control block diagram representation for power flow requirement and phase shifts for topology 1 according to an exemplary implementation of the present disclosure.

FIG. 5 illustrates control block diagram representation for power flow requirement and phase shifts for topology 2 according to an exemplary implementation of the present disclosure.

FIG. 6 illustrates control block diagram representation for power flow requirement and phase shifts for topology 3 according to an exemplary implementation of the present disclosure.

FIG. 7 illustrates a representative diagram of (a) typical DAB operation and waveforms (b) extended DAB representative circuit schematic for the power flow through the main transformer with parameters reflected to the primary side.

FIG. 8 illustrates a schematic diagram of Inter module transformer for (a) topology 1 (b) topology 2 (c) topology 3 according to an exemplary implementation of the present disclosure.

FIG. 9 illustrates a method for converting a medium voltage alternating current (MVAC) input into a plurality of low voltage direct current (LVDC) outputs according to an exemplary implementation of the present disclosure.

It should be appreciated by those skilled in the art that any block diagrams herein represent conceptual views of illustrative methods embodying the principles of the present disclosure. Similarly, it will be appreciated that any flow charts, flow diagrams, and the like represent various processes which may be substantially represented in computer readable medium and so executed by a computer or processor, whether or not such computer or processor is explicitly shown.

### DESCRIPTION OF EMBODIMENTS

The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings but are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. References in the specification to “one embodiment” or “an embodiment” mean that a particular feature, structure, characteristic, or function described in connection with the embodiment is included in at least one embodiment of the disclosure. The appearances of the phrase “in one embodiment” in various places in the specification are not necessarily all referring to the same embodiment.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Figures discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the disclosure. Terms first, second, and the like are used to differentiate between objects having the same terminology and are in no way intended to represent a chronological order, unless where explicitly stated otherwise. A set is defined as a non-empty set including at least one element.

In the following description, for purpose of explanation, specific details are set forth in order to provide an understanding of the present disclosure. It will be apparent, however, to one skilled in the art that the present disclosure may be practiced without these details. One skilled in the art will recognize that embodiments of the present disclosure, some of which are described below, may be incorporated into a number of systems. However, the systems and methods are not limited to the specific embodiments described herein. Further, structures and devices shown in the figures are illustrative of exemplary embodiments of the presently disclosure and are meant to avoid obscuring of the presently disclosure.

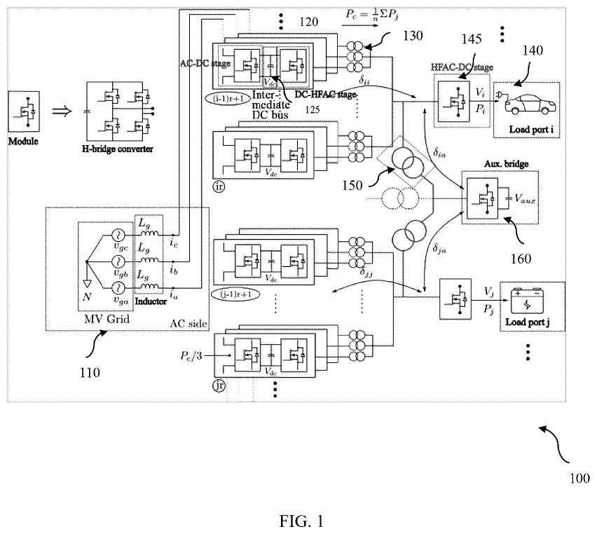

Various embodiments of the present disclosure are further described with reference to FIG. 1 to FIG. 9.

The various embodiments of the present disclosure describe techniques in the medium voltage AC to multiport low voltage DC converter with inter-module transformer (IMT) for EV charging stations.

The present disclosure generates multiple LVDC ports from MVAC that can handle wide variations in bidirectional power flow. The present disclosure doesn't require additional modifications in the HFT with medium voltage insulation. The present disclosure solution has the same semiconductor requirement as a single port solution with the same total power rating. Power balancing of multiple ports is achieved using either an additional multi-winding transformer or a number of two-winding transformers at the LV side. However, this multi-winding transformer doesn't require medium voltage insulation, making its design and manufacturing easier than existing multiport solutions.

The present disclosure provides a novel converter topology and its variation, whose diagrams are illustrated in FIGS. 1, 2, and 3.

The proposed topology utilizes a multi-level cascaded H-bridge (CHB) configuration to connect to the Medium Voltage AC (MVAC) source. In the proposed topology, each phase comprises n H-bridges, where the value of n is determined by the voltage rating of modules and the line to neutral MVAC voltage. The CHB is modulated using a phase-shifted modulation strategy, resulting in power factor corrected balanced three-phase currents drawn from the MVAC grid while maintaining the intermediate DC bus. The proposed converter has m load ports, where m is less than n in most practical scenarios. For the topology description in the disclosure, n is assumed to be an integral multiple of m. However, the analysis can also be extended even when this doesn't satisfy, but for m<n. Each load port is connected to r H-bridges of the CHB in each phase, such that m×r=n. Each H-bridge from the intermediate DC bus is connected to the primary winding of each two-winding high-frequency transformers, with the secondaries paralleled to form a high frequency alternating current (HFAC) node. A secondary H-bridge interfaces this HFAC node with the load port. These transformers are referred to as the main transformers, and for each Low Voltage DC (LVDC) load port, there are 3r main transformers and 3r H bridges from the intermediate DC buses maintained by the CHB. When all the load ports are loaded identically, the power flow is through cascaded H bridge (CHB), primary H bridge following the intermediate DC bus, main transformer, HFAC node and secondary H-bridge connected to the load port. Each single-phase module transfers a power of P_{c}=mPⱼ/3n where Pⱼ is the power at the j^{th} load port, m is the number of load ports and n is the number of CHB modules per phase. Each primary H-bridge connected to the intermediate DC bus is modulated with phase-shifts from all secondary H-bridges connected to the load ports to process a power of P_{c} through each module. However, even if the power demand at each load port is different, each CHB module still transfers equal power of P_{c} given as P_{c}=ΣPⱼ/3n. This results in excess or deficit of power at each HFAC node connected to the load through a secondary bridge. It should be noted that power imbalance at each load port is the normal operating scenario for the application discussed. The present disclosure aims to resolve this issue by introducing an inter-module transformer (IMT) at the low voltage side, as shown in FIGS. 1, 2 and 3.

The above-mentioned issue is addressed in three ways in the present disclosure, referred to as topologies 1, 2 and 3.

FIG. 1 illustrates block diagram representation of MVAC to multiport LVDC converter (Topology 1) using an additional bridge (aux) and m number of two-winding transformers according to an exemplary implementation of the present disclosure.

The FIG. 1 illustrates block diagram representation of MVAC to multiport LVDC converter (Topology 1) using an additional bridge (aux) and m number of two-winding transformers. The power converter topology 1 (100) for converting a medium voltage alternating current (MVAC) input to a plurality of low voltage direct current (LVDC) outputs comprises a plurality of cascaded H-bridge (CHB) converters (120) coupled to Medium Voltage AC (MVAC) source (110) to form an intermediate non-isolated DC bus (125) to receive the MVAC input. Each cascaded H-bridge converter comprises a plurality of primary modules operative with controlled low frequency modulation, with phase-shift pulse width modulation (PWM) method between series connected AC-DC modules to transfer power from the MVAC input. In an embodiment, each primary module consists of AC-DC H-bridge module, intermediate DC bus and DC-HFAC stage. The AC-DC H-bridge module of each primary module receives AC input and generates DC to the intermediate DC bus. The following DC-HFAC stage of the primary module uses this DC from intermediate DC bus and generates the corresponding HFAC node. The power converter topology or system (100) further comprises a plurality of main transformers (130) each correspondingly coupled to one of the plurality of DC-HFAC stage with the primary AC-DC H-bridge module of each cascaded H-bridge converter to generate an HFAC node, wherein each of the main transformers is configured to convert power from the intermediate DC bus into a high-frequency alternating current (HFAC) output and a plurality of load ports (140), wherein each load port is correspondingly coupled to one of the HFAC nodes via a secondary AC-DC H-bridge module (145) and configured to receive the HFAC output and provide an independent LVDC output at each of the load ports.

The present disclosure system (topology 1) further comprises an inter-module transformer (150) operatively coupled to each of the HFAC nodes and configured to balance power among the load ports by transferring an excess or deficit of load power between the load ports.

The present disclosure system (topology 1) further comprises an auxiliary bridge (160) electrically coupled to the inter-module transformer (150) and to an auxiliary DC bus, the auxiliary bridge configured to facilitate the routing of imbalanced power between the load ports via the inter-module transformer (150).

In an embodiment, each multi-level cascaded H-bridge converter comprises a plurality of primary AC-DC H-bridge modules per phase, each primary AC-DC H-bridge module is configured to transfer substantially equal power to the intermediate DC buses correspondingly.

The present disclosure system (topology 1) further comprises a plurality of high-frequency alternating current (HFAC) nodes configured to generate high-frequency alternating current (HFAC) outputs and provide independent LVDC output via plurality of load ports. Each of the plurality of high-frequency alternating current (HFAC) nodes is connected in a parallel configuration.

In the present disclosure, each main transformer (130) comprises primary winding and secondary winding, wherein each DC-HFAC stage with the primary AC-DC H-bridge module is coupled to the primary winding of each main transformer with the secondary windings paralleled to generate individual high frequency alternating current (HFAC) node. The main transformer is configured to operate at a predetermined high-frequency switching rate that is substantially consistent with the switching frequency of the H-bridge modules.

The inter-module transformer (150) comprises a plurality of two-winding transformers, each two-winding transformer operatively coupled between HFAC nodes of a respective load port and the auxiliary bridge to independently balance power among the load ports. In an embodiment, the inter-module transformer may be two-winding low voltage transformers. The inter-module transformer may be a multi-winding transformer having m windings or an (m+1) winding transformer that includes an additional winding.

In an embodiment, the inter-module transformer comprises a configuration selected from a group consisting of a plurality of two-winding transformers, a multi-winding transformer having m-windings, and an (m+1)-winding transformer that includes an additional winding.

In topology 1, m two-winding transformers are connected between the HFAC nodes of the individual load ports and the aux bridge connected to an auxiliary DC bus. Here, m is the number of load ports. The auxiliary DC bus denoted as Vₐᵤₓ doesn't process net active power and exists only to facilitate the mismatch in power at different load ports. All the main transformers process equal power from the AC side. Depending on the total power required in all ports, the excess or deficit in power is transferred via the auxiliary bridge. In topology 1, each load port interacts with the auxiliary bridge independently. The present disclosure system (topology 1) further comprises a control circuit configured to monitor load power levels at the load ports and adjust phase shifts of the H-bridge modules and the auxiliary bridge to facilitate routing of imbalanced power via the inter-module transformer. The load ports do not interact or transfer power directly with one another as multiple two-winding transformers are used. Unlike the solutions provided in the prior art for a multi-port solution, in the present disclosure no modification is done on the main transformer which requires medium voltage insulation.

It should be noted that modifying medium voltage transformers and realizing a multi-winding structure is quite challenging due to clearance and creepage requirements for the design with medium voltage insulation. The present disclosure topology 1 structure requires an additional auxiliary bridge and m two-winding transformers for realizing IMT, which can be reduced to save on core volume and the total number of windings.

In another embodiment, the present disclosure discloses a medium voltage alternating current (MVAC) to multiport low voltage dc (LVDC) converter. The converter comprises plurality of cascaded H-bridge (CHB) converters (120) coupled with Medium Voltage AC (MVAC) source (110) to form an intermediate non-isolated DC bus (125) to receive the MVAC input, wherein each cascaded H-bridge converter comprises a plurality of primary AC-DC H-bridge modules operative with controlled low frequency modulation signals with phase-shift modulation between series connected modules and configured to transfer power from the Medium Voltage AC (MVAC) input, a plurality of main transformers (130) each correspondingly coupled to each DC-HFAC stage of primary module of each cascaded H-bridge converter to generate an HFAC node, and configured to convert power from the intermediate DC bus into a high-frequency alternating current (HFAC) output and a plurality of load ports, each load port is correspondingly coupled to one of the HFAC nodes via a secondary AC-DC H-bridge module and configured to receive the HFAC output and convert the HFAC output to provide an independent LVDC output at each of the load ports.

The converter further comprises an inter-module transformer (150) operatively coupled to each of the HFAC nodes and configured to balance power among the load ports by transferring an excess or deficit of load power between the load ports.

In an embodiment, the inter-module transformer comprises a configuration selected from the group consisting of a plurality of two-winding transformers, a multi-winding transformer having m windings, and an (m+1) winding transformer that includes an additional winding.

The converter further comprises an auxiliary bridge (160) electrically coupled to the inter-module transformer (150) and to an auxiliary DC bus, the auxiliary bridge configured to facilitate the routing of imbalanced power between the load ports via the inter-module transformer and a control circuit configured to monitor power levels at the load ports and to adjust phase shifts of the H-bridge modules and the auxiliary bridge, thereby enabling the inter-module transformer to dynamically balance the load power across the plurality of load ports.

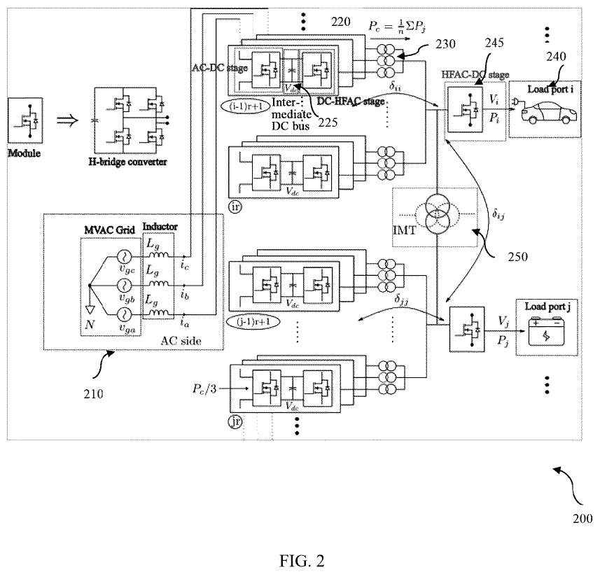

FIG. 2 illustrates block diagram representation of MVAC to multiport LVDC converter (topology 2) using m-winding Inter-Module Transformer (IMT) according to an exemplary implementation of the present disclosure. In the present disclosure, no additional switch count is required in terms of processing power compared to a single port solution.

The figure illustrates block diagram representation of MVAC to multiport LVDC converter (topology 2) using m-winding Inter-Module Transformer (IMT). The power converter topology 2 (200) for converting a medium voltage alternating current (MVAC) input to a plurality of low voltage direct current (LVDC) outputs comprises a plurality of cascaded H-bridge (CHB) converters (220) coupled to Medium Voltage AC (MVAC) source (210) to form an intermediate non-isolated DC bus (225) to receive the MVAC input. Each cascaded H-bridge converter comprises a plurality of primary modules operative with controlled low frequency modulation, with phase-shift PWM method between series connected AC-DC modules to transfer power from the MVAC input. In an embodiment, each primary module consists of AC-DC H-bridge module, intermediate DC bus and DC-HFAC stage. The AC-DC H-bridge module of each primary module receives AC input and generates DC to the intermediate DC bus. The following DC-HFAC stage of the primary module uses this DC from intermediate DC bus and generates the corresponding HFAC node. The power converter topology or system (200) further comprises a plurality of main transformers (230) each correspondingly coupled to one of the plurality of DC-HFAC stage with the primary AC-DC H-bridge module of each cascaded H-bridge converter to generate an HFAC node, wherein each of main transformers is configured to convert power from the intermediate DC bus into a high-frequency alternating current (HFAC) output and a plurality of load ports (240), wherein each load port is correspondingly coupled to one of the HFAC nodes via a secondary AC-DC H-bridge module (245) and configured to receive the HFAC output and provide an independent LVDC output at each of the load ports.

The present disclosure system (topology 2) further comprises an inter-module transformer (250) comprises a multi-winding transformer having m windings, each winding operatively coupled to the HFAC nodes and configured to balance power among the load ports by transferring an excess or deficit of load power between the load ports.

In an embodiment, the inter-module transformer (250) is a multi-winding transformer having m windings.

In topology 2, a m-winding inter-module transformer is used to interface the HFAC node of each individual load port. Here, IMT handles the deficit or excess power at the DC load ports and unlike in topology 1, the load ports interact with one another due to coupling between the multiple windings in the IMT. It should be noted that, multi-winding IMT can be realized with relative ease as compared to multi-winding main transformer, as it doesn't require medium voltage insulation.

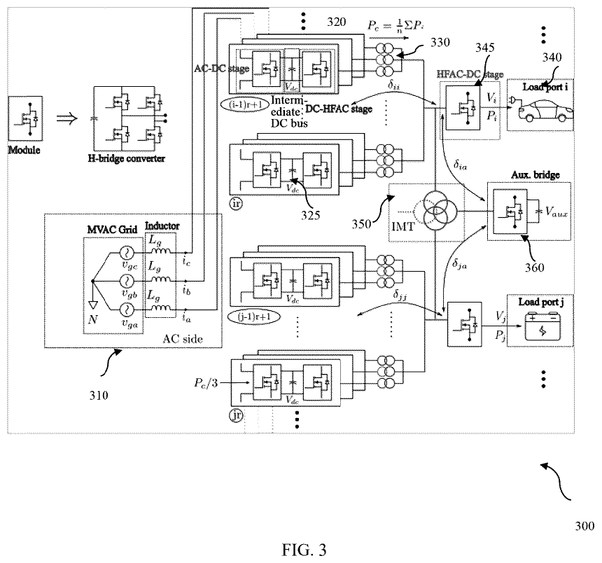

FIG. 3 illustrates block diagram representation of MVAC to multiport LVDC converter (Topology 3) using additional bridge (aux) and an (m+1) winding inter module transformer according to an exemplary implementation of the present disclosure.

The FIG. 3 illustrates block diagram representation of MVAC to multiport LVDC converter topology 3 using additional bridge (aux) and an (m+1) winding inter module transformers. The power converter topology 3 (300) for converting a medium voltage alternating current (MVAC) input to a plurality of low voltage direct current (LVDC) outputs comprises a plurality of cascaded H-bridge (CHB) converters (320) coupled to Medium Voltage AC (MVAC) source (310) to form an intermediate non-isolated DC bus (325) to receive the MVAC input. Each cascaded H-bridge converter comprises a plurality of primary modules operative with controlled low frequency modulation, with phase-shift modulation between series connected AC-DC modules to transfer power from the MVAC input. In an embodiment, each primary module consists of AC-DC H-bridge module, intermediate DC bus and DC-HFAC stage. The AC-DC H-bridge module of each primary module receives AC input and generates DC to the intermediate DC bus. The following DC-HFAC stage of the primary module uses this DC from intermediate DC bus and generates the corresponding HFAC node. The power converter topology or system (300) further comprises a plurality of main transformers (330) each correspondingly coupled to one of the plurality of DC-HFAC stage with the primary AC-DC H-bridge module of each cascaded H-bridge converter to generate an HFAC node, wherein the each of the main transformers is configured to convert power from the intermediate DC bus into a high-frequency alternating current (HFAC) output and a plurality of load ports (340), wherein each load port is correspondingly coupled to one of the HFAC nodes via a secondary AC-DC H-bridge module (345) and configured to receive the HFAC output and provide an independent LVDC output at each of the load ports

The present disclosure system (topology 3) further comprises an inter-module transformer (350) comprises a multi-winding transformer having m windings, each winding operatively coupled to the HFAC nodes of corresponding load port and the auxiliary bridge and configured to balance power among the load ports by transferring an excess or deficit of load power between the load ports.

In an embodiment, the inter-module transformer (350) is (m+1) winding inter module transformer. In topology 3, the coupling between different load ports is eliminated with the use of an additional auxiliary bridge and an additional winding in the multi-winding inter module transformer. This simplifies the operation and control while adding only one aux. bridge and an additional winding on the IMT as compared to topology 2.

In the present disclosure, the semiconductor VA requirement is the same compared to the single port solution. However, the single port solution usually requires a higher number of semiconductors compared to the proposed configurations.

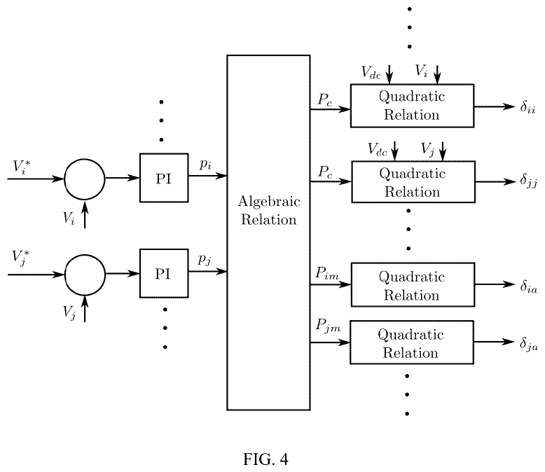

FIG. 4 illustrates control block diagram representation for power flow requirement and phase shifts for topology 1 according to an exemplary implementation of the present disclosure.

The figure illustrates control block diagram representation for power flow requirement and phase shifts for the topology 1. The present disclosure utilizes Dual active bridge (DAB) modulation, which refers to switching strategies for all H-bridges except those in the multi-level cascaded H-bridge (CHB) configuration. In the proposed embodiment, it is assumed that there is no power loss in the converter, and the magnetizing inductance of the transformer is very high. All H-bridges are modulated with a square wave of a predetermined switching frequency (fₛ) with a duty ratio of 50%. The main transformer's operating frequency is also fₛ. Each of the 3r DC-HFAC primary H-bridges catering to a DC load port j is identically modulated with a phase shift of δⱼⱼ with respect to the square wave generated for the H-bridge connected to port j, similarly for all other ports like δⱼⱼ for port i.

Power flow routing is discussed in this section considering i^{th} and j^{th} modules. Power flow and phase shift for topology 1 are analyzed in four different cases for clarity. All the bridges are square wave modulated with auxiliary bridge being the reference wave, other bridges are phase shifted with respect to the auxiliary bridge. All modules including i^{th} module and j^{th} module are modulated to transfer the same amount of power P_{c}=(1/n)ΣPᵢ through the main transformer. Pᵢₘ is the power transferred to the IMT from i^{th} module which is 3rP_{c}−pᵢ. Where pᵢ is the instantaneous power delivered by the converter to the port i.

When Pᵢ=Pⱼ and Vᵢ=Vⱼ:
δᵢᵢ and δⱼⱼ are related to this P_{c}, V_{dc}, Vᵢ and Vⱼ by the quadratic relation given in next section. Since Vᵢ and Vⱼ are equal, δᵢᵢ and δⱼⱼ are equal for both the modules to transfer same amount of power P_{c} through the main transformer. The IMT is modulated to handle the imbalance in power from the load ports. For the i^{th} port the difference in power coming through the main transformer and the power going to the load 3rP_{c}−Pᵢ will be pushed to the aux bridge with a phase shift δᵢₐ which is a function of P_{c}, Pᵢ, Vᵢ and Vₐᵤₓ given in next section. Similarly, for the j^{th} port. Since Pᵢ=Pⱼ, δᵢₐ=δⱼₐ for same amount of power to be pushed to the aux bridge.

When Pᵢ=Pⱼ and Vᵢ≠Vⱼ:
δᵢᵢ and δⱼⱼ are based on the power P_{c} to be transferred through the main transformer. Though Pᵢ=Pⱼ, δᵢᵢ≠δⱼⱼ to transfer same P_{c} through i^{th} and j^{th} module since Vᵢ≠Vⱼ and the power transferred is a function of Vᵢ and Vⱼ respectively. The deficit or excess in power to the auxiliary bridge, which is P_{c}−Pᵢ for the i^{th} module and P_{c}−Pⱼ for the j^{th} module is the same. But the phase shifts δᵢₐ≠δⱼₐ as the power is a function of Vᵢ and Vⱼ.

When Pᵢ≠Pⱼ and Vᵢ=Vⱼ:
δᵢᵢ and δⱼⱼ are based on the power P_{c} to be transferred through the main transformer. Since Vᵢ=Vⱼ, δᵢᵢ=δⱼⱼ to transfer same P_{c} through i^{th} and j^{th} modules. The deficit or excess in power to the auxiliary bridge, which is 3rP_{c}−Pᵢ for the i^{th} module and 3rP_{c}−Pⱼ for the j^{th} module are different. Therefore, the phase shifts δᵢₐ≠δⱼₐ as the powers are different.

When Pᵢ≠Pⱼ and Vᵢ≠Vⱼ:
δᵢᵢ and δⱼⱼ are based on the power P_{c} to be transferred through the main transformer. Since Vᵢ≠Vⱼ, δᵢᵢ≠δⱼⱼ to transfer same P_{c} through i^{th} and j^{th} modules. The deficit or excess in power to the auxiliary bridge is 3rP_{c}−Pᵢ for the i^{th} module and 3rP_{c}−Pⱼ for the j^{th} module which are different. Therefore, the phase shifts δᵢₐ≠δⱼₐ as the powers are different.

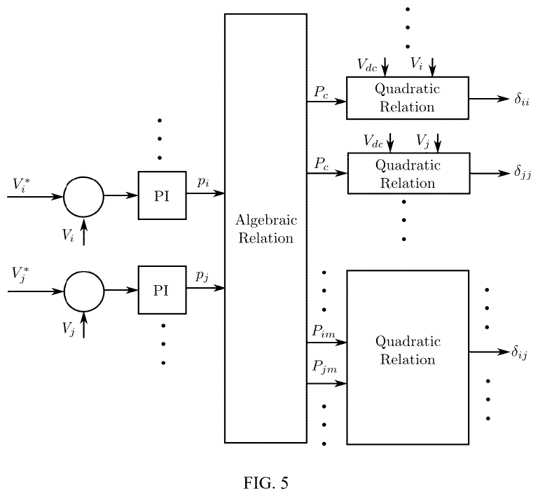

FIG. 5 illustrates control block diagram representation for power flow requirement and phase shifts for topology 2 according to an exemplary implementation of the present disclosure.

The figure illustrates control block diagram representation for power flow requirement and phase shifts for topology 2. The analysis is continued for topology 2 considering i^{th} and j^{th} modules for four different cases. All the bridges are square wave modulated with 50% duty ratio with the port 1 load side H-bridge being the reference, all other bridges are phase shifted with respect to this bridge. Similar to topology 1, all modules including i^{th} module and j^{th} module are modulated to transfer the same amount of power P_{c}=(1/n)ΣPᵢ through the main transformer from the AC side.

When Pᵢ=Pⱼ and Vᵢ=Vⱼ:
δᵢᵢ=δⱼⱼ as both the modules transfer same amount of power P_{c} from AC side, which is a function of V_{dc}, Vᵢ and Vⱼ by the quadratic relation given in next section. δᵢⱼ=0 since i^{th} port and j^{th} port have same power requirement which makes the deficit or excess of power that is transfers with the IMT to be same. In order to achieve this they both the bridges have to be in phase.

When Pᵢ=Pⱼ and Vᵢ≠Vⱼ:
δᵢᵢ≠δⱼⱼ though the power P_{c} transferred in i^{th} and j^{th} modules, is same as it is a function of V_{dc} & Vᵢ for the i^{th} module and V_{dc} & Vⱼ for the j^{th} module. δᵢⱼ≠0 though both the modules have same power requirement with the IMT. To transfer same amount of power from/to IMT with different port voltages Vᵢ and Vⱼ the phase shifts of i^{th} and j^{th} ports from the reference port will be different which makes δᵢⱼ≠0.

When Pᵢ≠Pⱼ and Vᵢ=Vⱼ:
δᵢᵢ=δⱼⱼ as the power P_{c} transferred in i^{th} and j^{th} ports, is same which is a function of V_{dc} & Vᵢ for the i^{th} module and V_{dc} & Vⱼ for the j^{th} module. δᵢⱼ≠0 as both the ports have different power requirement from the IMT and therefore phase shifted by different amount from the reference bridge.

When Pᵢ≠Pⱼ and Vᵢ≠Vⱼ:
δᵢᵢ≠δⱼⱼ though the power P_{c} transferred in i^{th} and j^{th} modules, is same as it is a function of V_{dc} & Vᵢ for the i^{th} module and V_{dc} & Vⱼ for the j^{th} module. δᵢⱼ≠0 as both the ports have different power requirement from the IMT and therefore phase shifted by different amount from the reference bridge.

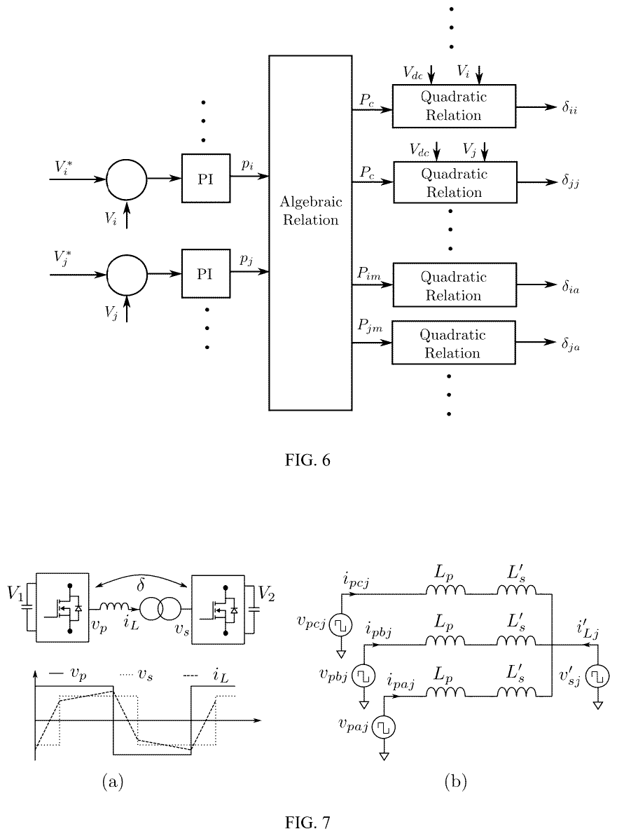

FIG. 6 illustrates control block diagram representation for power flow requirement and phase shifts for topology 3 according to an exemplary implementation of the present disclosure.

The figure illustrates control block diagram representation for power flow requirement and phase shifts for the topology 3. Similar analysis is continued for topology 3 considering i^{th} and j^{th} modules for four different cases. All the bridges are square wave modulated with auxiliary bridge being the reference bridge, other bridges are phase shifted with respect to the auxiliary bridge. All modules including i^{th} module and j^{th} module are modulated to transfer the same amount of power P_{c}=(1/n)ΣPᵢ through the main transformer. Pᵢₘ is the power transferred to the IMT from i^{th} module which is 3rP_{c}−pᵢ. Where pᵢ is the instantaneous power delivered to by the converter at the port i.

When Pᵢ=Pⱼ and Vᵢ=Vⱼ:
δᵢᵢ and δⱼⱼ are related to this P_{c}, V_{dc}, Vᵢ and Vⱼ by the quadratic relation given in next section. Since Vᵢ and Vⱼ are equal, δᵢᵢ and δⱼⱼ are equal for both the modules to transfer same amount of power P_{c} through the main transformer. The IMT is modulated to handle the imbalance in power from the load ports. For the i^{th} port the difference in power coming through the main transformer and the power going to the load 3rP_{c}−Pᵢ will be pushed to the aux bridge with a phase shift δᵢₐ which is a function of P_{c}, Pᵢ, Vᵢ and Vₐᵤₓ given in next section. Similarly, for the j^{th} port. Since Pᵢ=Pⱼ, δᵢₐ=δⱼₐ for same amount of power to be pushed to the aux bridge.

When Pᵢ=Pⱼ and Vᵢ≠Vⱼ:
δᵢᵢ and δⱼⱼ are based on the power P_{c} to be transferred through the main transformer. Though Pᵢ=Pⱼ, δᵢᵢ≠δⱼⱼ to transfer same P_{c} through i^{th} and j^{th} modules since Vᵢ≠Vⱼ and the power transferred is a function of Vᵢ and Vⱼ respectively. The deficit or excess in power to the auxiliary bridge, which is P_{c}−Pᵢ for the i^{th} module and P_{c}−Pⱼ for the j^{th} module is the same. But the phase shifts δᵢₐ≠δⱼₐ as the power is a function of Vᵢ and Vⱼ.

When Pᵢ≠Pⱼ and Vᵢ=Vⱼ:
δᵢᵢ and δⱼⱼ are based on the power P_{c} to be transferred through the main transformer. Since Vᵢ=Vⱼ, δᵢᵢ=δⱼⱼ to transfer same P_{c} through i^{th} and j^{th} modules. The deficit or excess in power to the auxiliary bridge, which is 3rP_{c}−Pᵢ for the i^{th} module and 3rP_{c}−Pⱼ for the j^{th} module are different. Therefore, the phase shifts δᵢₐ≠δⱼₐ as the powers are different.

When Pᵢ≠Pⱼ and Vᵢ≠Vⱼ:
δᵢᵢ and δⱼⱼ are based on the power P_{c} to be transferred through the main transformer. Since Vᵢ≠Vⱼ, δᵢᵢ≠δⱼⱼ to transfer same P_{c} through i^{th} and j^{th} modules. The deficit or excess in power to the auxiliary bridge is 3rP_{c}−Pᵢ for the i^{th} module and 3rP_{c}−Pⱼ for the j^{th} module which are different. Therefore, the phase shifts δᵢₐ≠δⱼₐ as the powers are different.

FIG. 7 illustrates a representative diagram of (a) typical DAB operation and waveforms (b) extended DAB representative circuit schematic for the power flow through the main transformer with variables reflected to the primary side.

The mathematical relation between the phase shifts and the power flow derived in this DAB converter is shown. In the schematic for DAB with the main transformer, Lₚ represents the series inductance connected to the poles of each of the 3n H-bridges that interface the intermediate DC link (floating DCs) of the CHBs and the primary winding of the main transformers. Lₛ is the series inductance between the poles of H-bridge interfacing an LVDC load port and the secondary of the main transformer. It is reflected to the primary side of the main transformer with a turns-ratio of 1:h such that L′ₛ=Lₛ/h². This series inductance could also be achieved by incorporating it within the leakage inductance of the transformer.

The power transferred for a Single-phase shift (SPS) modulated dual active bridge (DAB) with phase shift δ with waveforms shown in FIG. 7(a) is given in (1). Similarly, for the main transformer, the relation between active power and phase shift for the j^{th} module through the main transformer is given in (2). The power flow in main transformer can be considered as a combination of three DABs connected in parallel. Lₛⱼ is the equivalent inductance seen from primary to secondary in the j^{th} module for the equivalent circuit shown in FIG. 7(b), which is Lₛⱼ=L′ₛ+Lₚ.

$$P = \frac{{V}_{1} {V}_{2}}{8 {f}_{s} L} δ ( 2 - \vert δ \vert ) \qquad ( 1 )$$

$${P}_{c} = \frac{3 {V}_{dc} {V}_{j}}{8 h {f}_{s} {L}_{s j}} {δ}_{j j} ( 2 - \vert {δ}_{j j} \vert ) \qquad ( 2 )$$

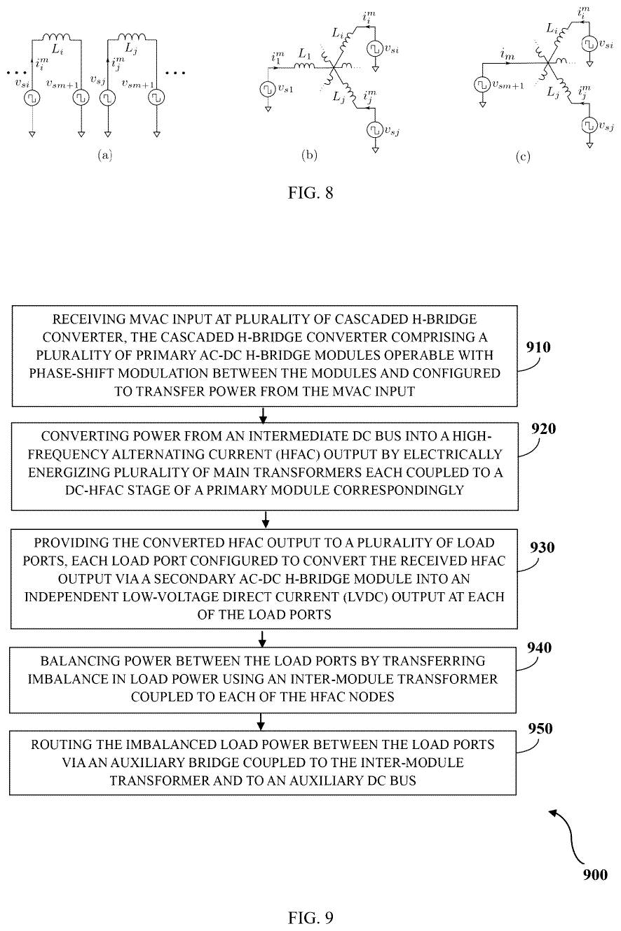

FIG. 8 illustrates a schematic diagram of Inter module transformer for (a) topology 1 (b) topology 2 (c) topology 3 according to an exemplary implementation of the present disclosure.

The modulation of inter-module transformers differs for different topologies. In topology 1, one high-frequency transformer is connected between the HF side of each DC port and that of auxiliary bus. The schematic for this is shown in FIG. 8(a). The power transferred from each port to the aux bus is given in (3), where δᵢₐ is the phase shift between the auxiliary bridge and the H bridge connected to the i^{th} load port. Lᵢ is the equivalent series inductance in between i^{th} port to the auxiliary bridge. For topology 2, the schematic is given in FIG. 8(b), and the relation of power flow and phase shift between any two ports is given in (4). Here δᵢⱼ is the phase shift between i^{th} and j^{th} load port, and Lᵢ is the series inductance from i^{th} load port to the i^{th} winding of IMT. Here, Lᵢⱼ is the equivalent series inductance between i^{th} and j^{th} load ports. The turns ratio of IMT is chosen to be 1:1 . . . :1. Vᵢ is the DC bus voltage of port i, and Vⱼ is the DC bus voltage of the port j. The schematic for topology 3 is shown in FIG. 8(c). The power transferred from each port to the aux bus is given in (5), where δᵢₐ is the phase shift between the auxiliary bridge and the H bridge connected to the i^{th} load port. Lᵢ is the equivalent series inductance in between i^{th} port to the auxiliary bridge.

$${P}_{i m} = \frac{{V}_{i} {V}_{a u x}}{8 {f}_{s} {L}_{i}} {δ}_{ia} ( 2 - \vert {δ}_{ia} \vert ) \qquad ( 3 )$$

$${P}_{i j} = \frac{{V}_{i} {V}_{j}}{8 {f}_{s} {L}_{i j}} {δ}_{i j} ( 2 - \vert {δ}_{i j} \vert ) \qquad ( 4 )$$

$${P}_{i m} = \frac{{V}_{i} {V}_{a u x}}{8 {f}_{s} {L}_{i}} {δ}_{i a} ( 2 - \vert {δ}_{i a} \vert ) \qquad ( 5 )$$

FIG. 9 illustrates a method for converting a medium voltage alternating current (MVAC) input into a plurality of low voltage direct current (LVDC) outputs according to an exemplary implementation of the present disclosure.

The FIG. 9 illustrates the method (900) for converting a medium voltage alternating current (MVAC) input into a plurality of low voltage direct current (LVDC) outputs. The method comprises receiving (910) MVAC input at plurality of cascaded H-bridge converter, the cascaded H-bridge converter comprising a plurality of primary AC-DC H-bridge modules operable with phase-shift modulation and configured to form an intermediate non-isolated DC bus and configured to transfer power from the MVAC input, converting (920) power from the intermediate DC bus into a high-frequency alternating current (HFAC) output by electrically energizing plurality of main transformers coupled to a DC-HFAC stage of a primary module correspondingly of each cascaded H-bridge converter, providing (930) the converted HFAC output to a plurality of load ports, each load port is configured to convert the received HFAC output via a secondary AC-DC H-bridge module into an independent LVDC output at each load port and balancing (940) load power between the load ports by transferring imbalance in load power using an inter-module transformer designed for low voltage operation coupled to each of the HFAC nodes.

The present method further comprises routing (950) the imbalanced load power between the load ports via an auxiliary bridge electrically coupled to the inter-module transformer and to an auxiliary DC bus. The method further comprises monitoring power levels at the load ports via a control circuit and adjusting phase shifts applied to H-bridge modules and the auxiliary bridge, thereby enabling the inter-module transformer to dynamically balance the load power across the plurality of load ports.

The present method comprises modulating the AC-DC stage of primary modules using phase-shift modulation between series connected modules, where the AC-DC stage of the primary modules is low frequency switched and modulated based on average load power requirements of the load ports.

In one embodiment, three variations of a novel converter topology with applications in medium voltage AC to multiport low voltage DC are disclosed in the present disclosure.

In an advantageous aspect of the present disclosure, the converter topologies eliminate bulky LFT utilized for the isolation of MVAC from the LVDC ports.

In another advantageous aspect of the present disclosure, the power rating of semiconductor modules doesn't increase as compared to a safe operating area (SOA) with a single port solution with same total power rating.

In the present disclosure, multiple isolated LVDC ports are generated by introducing a novel inter-module transformer, and its modulation. In the present disclosure, three variants of the IT are also proposed.

In another advantageous aspect of the present disclosure, the converter topology doesn't necessitate modifications in the main transformer, which transfers power from AC to the DC side, and that requires medium voltage isolation.

In another advantageous aspect of the present disclosure, the additional IT on the low voltage side, is easy to realize as compared to medium voltage insulated multi-winding transformer.

In another advantageous aspect of the present disclosure, the IT could either be easily realized with a combination of multiple two-winding transformers interfaced using an auxiliary bridge or using only a single multi-winding transformer to reduce the core volume and size, or using the same with an auxiliary bridge.

In one embodiment, the present disclosure provides a concept of multi-winding LV insulated IMT at HFAC nodes of load ports to address the excess or deficit of load power between the multiple DC ports.

In another embodiment, the present disclosure provides a concept of using multiple two winding transformers with auxiliary bridge to handle the excess or deficit of load power between the LVDC ports.

In another embodiment, the present disclosure provides a concept of using single multi-winding LV insulated IMT with auxiliary bridge at HFAC nodes of load ports to address the excess or deficit of load power between the multiple DC ports.

In another advantageous aspect of the present disclosure, the converter topology improves sizing, power flow and modulation in such an IMT during DC load power imbalance scenarios.

In another advantageous aspect of the present disclosure, the converter topology improves sizing, power flow, and control of Vₐᵤₓ at the auxiliary bridge during load power imbalance scenarios.

According to the implementation described above, challenges such as the requirement for medium voltage isolation in multi-winding HFTs due to high common mode voltage (CMV), as the primary in the multi-winding HFTs is fed from an H-bridge on the AC side, would be overcome.

The various embodiments described above are specific examples of a single broader disclosure. Any modifications, alterations or the equivalents of the above-mentioned embodiments pertain to the same disclosure as long as they are not falling beyond the scope of the disclosure as defined by the appended claims. It will be apparent to a person skilled in the art that the medium voltage AC to multiport low voltage DC converter with inter-module transformer (IMT) for charging stations may be provided using some or many of the above-mentioned features or components without departing from the scope of the disclosure. It will be also apparent to a skilled person that the embodiments described above are specific examples of a single broader disclosure which may have greater scope than any of the singular descriptions taught. There may be many alterations made in the disclosure without departing from the spirit and scope of the disclosure.

Figures are merely representational and are not drawn to scale. Certain portions thereof may be exaggerated, while others may be minimized. Figures illustrate various embodiments of the disclosure that can be understood and appropriately carried out by those of ordinary skill in the art.

In the foregoing detailed description of embodiments of the disclosure, various features are grouped together in a single embodiment for the purpose of streamlining the disclosure. This method of disclosure is not to be interpreted as reflecting an intention that the claimed embodiments of the disclosure require more features than are expressly recited in each claim. Rather, as the following claims reflect, inventive subject matter lies in less than all features of a single disclosed embodiment. Thus, the following claims are hereby incorporated into the detailed description of embodiments of the disclosure, with each claim standing on its own as a separate embodiment.

It is understood that the above description is intended to be illustrative, and not restrictive. It is intended to cover all alternatives, modifications and equivalents as may be included within the spirit and scope of the disclosure as defined in the appended claims. Many other embodiments will be apparent to those of skill in the art upon reviewing the above description. The scope of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively.

What is claimed is:

1. A power converter system, comprising:
a plurality of cascaded H-bridge (CHB) converters configured to receive a medium voltage AC (MVAC) input, wherein each of the cascaded H-bridge converter comprises a plurality of primary modules configured to transfer power from the MVAC input;
a plurality of main transformers each correspondingly coupled to one of a plurality of DC-HFAC stage with a primary AC-DC H-bridge module, wherein each of the main transformers is configured to convert power from an intermediate DC bus to a high-frequency alternating current (HFAC) node for output; and
a plurality of load ports each correspondingly coupled to one of HFAC nodes via a secondary AC-DC H-bridge module for individually providing an independent low voltage direct current (LVDC) output at each of the load ports.

2. The power converter system as claimed in claim 1, further comprising an inter-module transformer coupled to each of the HFAC nodes and configured to balance power among the load ports.

3. The power converter system as claimed in claim 2, further comprising an auxiliary bridge coupled to the inter-module transformer and to an auxiliary DC bus, the auxiliary bridge configured to facilitate the routing of imbalanced power between the load ports via the inter-module transformer.

4. The power converter system as claimed in claim 1, wherein each cascaded H-bridge converter comprises a plurality of primary AC-DC H-bridge modules per phase, each primary AC-DC H-bridge module is configured to transfer substantially equal power to the intermediate DC buses correspondingly.

5. The power converter system as claimed in claim 1, further comprising a plurality of high-frequency alternating current (HFAC) nodes configured to generate high-frequency alternating current (HFAC) outputs and provide independent LVDC output via plurality of load ports.

6. The power converter system as claimed in claim 1, wherein each main transformer comprises primary winding and secondary winding, wherein each DC-HFAC stage with the primary AC-DC H-bridge module is coupled to the primary winding of each main transformer with the secondary windings paralleled to generate individual high frequency alternating current (HFAC) node.

7. The power converter system as claimed in claim 5, wherein each of the plurality of high-frequency alternating current (HFAC) nodes is connected in a parallel configuration.

8. The power converter system as claimed in claim 2, wherein the inter-module transformer comprises a plurality of two-winding transformers, each two-winding transformer coupled between HFAC nodes of a respective load port and the auxiliary bridge to balance power among the load ports.

9. The power converter system as claimed in claim 2, wherein the inter-module transformer comprises a multi-winding transformer having m windings, each winding coupled to the HFAC nodes for balancing a HFAC output among the load ports.

10. The power converter system as claimed in claim 2, wherein the inter-module transformer comprises a multi-winding transformer having m windings, each winding coupled to the HFAC nodes of corresponding load port and the auxiliary bridge to balance power among the load ports.

11. The power converter system as claimed in claim 3, further comprising a control circuit configured to monitor load power levels at the load ports and adjust phase shifts of the H-bridge modules and the auxiliary bridge to facilitate routing of imbalanced power via the inter-module transformer.

12. The power converter system as claimed in claim 1, wherein the main transformer is configured to operate at a predetermined high-frequency switching rate that is substantially consistent with the switching frequency of the H-bridge modules.

13. A medium voltage alternating current (MVAC) to multiport low voltage dc (LVDC) converter, the converter comprising:
a plurality of cascaded H-bridge (CHB) converters configured to receive a Medium Voltage AC (MVAC) input, wherein each of the cascaded H-bridge converter comprises a plurality of primary AC-DC H-bridge modules operative with controlled low frequency modulation signals with phase-shift modulation between series connected modules and configured to transfer power from the Medium Voltage AC (MVAC) input;
a plurality of main transformers each correspondingly coupled to one of the primary AC-DC H-bridge modules to form an HFAC node, wherein each of the main transformers is configured to convert power from an intermediate DC bus to a DC-HFAC stage of a primary module into a high-frequency alternating current (HFAC) output; and
a plurality of load ports each correspondingly coupled to one of the HFAC nodes via a secondary AC-DC H-bridge module for individually providing an independent low voltage direct current (LVDC) output at each of the load ports.

14. The converter as claimed in claim 13, further comprising an inter-module transformer coupled to each of the HFAC nodes and configured to balance power between the load ports by transferring load power, wherein the inter-module transformer comprises a configuration selected from a group consisting of a plurality of two-winding transformers, a multi-winding transformer having m windings, and an (m+1) winding transformer that includes an additional winding.

15. The converter as claimed in claim 14, further comprising an auxiliary bridge coupled to the inter-module transformer and to an auxiliary DC bus, the auxiliary bridge configured to facilitate the routing of imbalanced power between the load ports via the inter-module transformer.

16. A method for converting a medium voltage alternating current (MVAC) input into a plurality of low voltage direct current (LVDC) outputs, the method comprising:
receiving MVAC input at plurality of cascaded H-bridge converter, the cascaded H-bridge converter comprising a plurality of primary AC-DC H-bridge modules operable with phase-shift modulation between the modules and configured to transfer power from the MVAC input;
converting power from an intermediate DC bus into a high-frequency alternating current (HFAC) output by electrically energizing plurality of main transformers each coupled to a DC-HFAC stage of a primary module correspondingly; and
providing the converted HFAC output to a plurality of load ports, each load port configured to convert the received HFAC output via a secondary AC-DC H-bridge module into an independent low voltage direct current (LVDC) output at each of the load ports.

17. The method as claimed in claim 16, further comprising balancing power between the load ports by transferring imbalance in load power using an inter-module transformer coupled to each of the HFAC nodes.

18. The method as claimed in claim 16, further comprising routing the imbalanced load power between the load ports via an auxiliary bridge coupled to the inter-module transformer and to an auxiliary DC bus.

19. The method as claimed in claim 16, further comprising monitoring power levels at the load ports via a control circuit and adjusting phase shifts applied to H-bridge modules and the auxiliary bridge, thereby enabling the inter-module transformer to dynamically balance the load power across the plurality of load ports.

20. The method as claimed in claim 16, further comprising modulating the AC-DC stage of primary modules using phase-shift modulation between series connected modules, where the AC-DC stage of the primary modules are low frequency switched and modulated based on average load power requirements of the load ports.
